(19) United States
(12) Patent Application Publication
(10) Pub. No.: US 2025/0184521 A1
(43) Pub. Date: Jun. 5, 2025

(54) FEATURE EXTRACTION METHOD AND APPARATUS FOR VIDEO, SLICING METHOD AND APPARATUS FOR VIDEO, AND ELECTRONIC DEVICE AND STORAGE MEDIUM

(71) Applicant: Lemon Inc., Grand Cayman (KY)

(72) Inventors: Xinyao WANG, Los Angeles, CA (US); Longyin WEN, Los Angeles, CA (US); Congcong LI, Beijing (CN); Dexiang HONG, Beijing (CN)

(21) Appl. No.: 18/837,577

(22) PCT Filed: Feb. 7, 2023
(86) PCT No.: PCT/SG2023/050063

§ 371 Date: Aug. 9, 2024

(30) Foreign Application Priority Data
Feb. 11, 2022 (CN) 202210127846.6

(51) Int. Cl. H04N 19/513; H04N 19/105; H04N 19/119; H04N 19/136; H04N 19/177; H04N 19/593

(52) U.S. Cl. CPC H04N 19/513; H04N 19/105; H04N 19/119; H04N 19/136; H04N 19/177; H04N 19/593

(57) ABSTRACT

A feature extraction method and apparatus for a video, a slicing method and apparatus for a video, and an electronic device and a storage medium. The method includes: determining a plurality of groups of pictures of video data, in which each group of pictures includes, according to a time sequence, an intra coding frame and at least one predictive-frame; for each group of pictures, extracting a first frame feature of the intra coding frame, and extracting a compensation feature of motion compensation information of the at least one predictive-frame relative to the intra coding frame; and updating the compensation feature according to the first frame feature to obtain a second frame feature of the at least one predictive-frame, so as to obtain a frame feature of a video frame in the video data.

The present application claims priority and benefits of Chinese Patent Application No. 202210127846.6, filed on Feb. 11, 2022 with the Chinese Patent Office, which is incorporated herein by reference in its entirety as part of the present application.

### TECHNICAL FIELD

Embodiments of the present disclosure relate to the field of computer technology, for example, to a feature extraction method and apparatus for a video, a slicing method and apparatus for a video, and an electronic device and a storage medium.

### BACKGROUND

Video data can be considered as data obtained by compressing and encoding a plurality of video frames according to video image compression standards in related technology. A feature extraction method for a video in the related technology is usually to decode the video data into the plurality of video frames, and then extract the features of plurality of video frames. A slicing method in the related technology is usually based on the above feature extraction method, which may include: decoding the video data into the plurality of video frames, and predicting whether each frame is the boundary; inputting front and back frames of the current frame into network during predicting each frame under a condition of considering the context information on a time domain, and extracting the features of the plurality of inputted frames based on the network, and predicting; and slicing according to the predicted boundary.

The shortcomings of the feature extraction method in the related technology include at least the following: the consumption of a large amount of storage space for storing the decoded video frames, and the consumption of a certain amount of decoding time. In addition to the above-mentioned shortcomings, the slicing method in the related technology also includes at least the following drawbacks: it is needed to extract the features of the inputted frame again when predicting each frame, which introduces a large number of redundant computations and greatly reduces the slicing efficiency.

### SUMMARY

An embodiment of the present disclosure provides a feature extraction method and apparatus for a video, a slicing method and apparatus for a video, and an electronic device and a storage medium, in which the feature extraction method is able to save storage space, and reduce decoding time; and the slicing method is able to avoid redundant computation, and improve slicing efficiency.

In a first aspect, embodiments of the present disclosure provide a feature extraction method for a video, and the method includes:
determining a plurality of groups of pictures of video data, in which each group of pictures includes, according to a time sequence, an intra coding frame and at least one predictive-frame;
for each group of pictures, extracting a first frame feature of the intra coding frame, and extracting a compensation feature of motion compensation information of the at least one predictive-frame relative to the intra coding frame; and
updating the compensation feature according to the first frame feature to obtain a second frame feature of the at least one predictive-frame, so as to obtain a frame feature of a video frame in the video data.

In a second aspect, embodiments of the present disclosure provide a slicing method for a video, and the method includes:
determining a frame feature of a video frame in target video data;
determining a candidate boundary frame of the target video data, determining a left feature according to a frame feature of a video frame that is in front of the candidate boundary frame in a time sequence, and determining a right feature according to a frame feature of a video frame that is behind the candidate boundary frame in the time sequence;
inputting the left feature and the right feature into a pre-trained classifier, so as to enable the classifier to determine whether the candidate boundary frame is a target boundary frame or not, and slicing the target video data according to the target boundary frame.

In a third aspect, embodiments of the present disclosure further provide a feature extraction apparatus for a video, and the apparatus includes: a group of pictures determination module, a feature extraction module and a feature updating module;
the group of pictures determination module is configured to determine a plurality of groups of pictures of video data, in which each group of pictures includes, according to a time sequence, an intra coding frame and at least one predictive-frame;
the feature extraction module is configured to, for each group of pictures, extract a first frame feature of the intra coding frame, and extract a compensation feature of motion compensation information of the at least one predictive-frame relative to the intra coding frame;
the feature updating module is configured to update the compensation feature according to the first frame feature to obtain a second frame feature of the at least one predictive-frame, so as to obtain a frame feature of a video frame in the video data.

In a fourth aspect, embodiments of the present disclosure further provide a slicing apparatus for a video, and the apparatus includes: a frame feature determination module, a bilateral feature determination module and a slicing module;
the frame feature determination module is configured to a frame feature of a video frame in target video data;
the bilateral feature determination module is configured to determine a candidate boundary frame of the target video data, determine a left feature according to a frame feature of a video frame that is in front of the candidate boundary frame in a time sequence, and determine a right feature according to a frame feature of a video frame that is behind the candidate boundary frame in the time sequence;
the slicing module is configured to input the left feature and the right feature into a pre-trained classifier, so as to enable the classifier to determine whether the candidate boundary frame is a target boundary frame or not, and slicing the target video data according to the target boundary frame.

In a fifth aspect, embodiments of the present disclosure further provide an electronic device, the electronic device includes:
at least one processor;
a storage apparatus is configured to store at least one program,
in which the at least one program, when executed by the at least one processor, causes the at least one processor to implement the feature extraction method for the video as described in any one of the embodiments of the present disclosure, or to implement the slicing method for the video as described in any one of the embodiments of the present disclosure.

In a sixth aspect, embodiments of the present disclosure further provide a storage medium includes computer-executable instructions, in which the computer-executable instructions, when executed by a computer processor, are used to perform the feature extraction method for the video as described in any one of the embodiments of the present disclosure, or to perform the slicing method for the video as described in any one of the embodiments of the present disclosure.

### BRIEF DESCRIPTION OF DRAWINGS

Throughout the accompanying drawings, identical or similar drawing marks indicate the identical or similar elements. It is to be understood that the accompanying drawings are schematic in nature and that the originals and elements are not necessarily drawn to scale.

FIG. 1 is a flow schematic diagram of a feature extraction method for a video according to an embodiment of the present disclosure;

FIG. 2 is a flow block diagram of updating a compensation feature in a feature extraction method for a video according to an embodiment of the present disclosure;

FIG. 3 is a flow schematic diagram of a feature extraction method for a video according to another embodiment of the present disclosure;

FIG. 4 is a flow block diagram of a feature extraction method for a video according to an embodiment of the present disclosure;

FIG. 5 is a flow schematic diagram of a slicing method for a video according to an embodiment of the present disclosure;

FIG. 6 is a flow block diagram of a training classifier in a slicing method for a video according to an embodiment of the present disclosure;

FIG. 7 is a structure schematic diagram of a feature extraction apparatus for a video according to an embodiment of the present disclosure;

FIG. 8 is a structure schematic diagram of a slicing apparatus for a video according to an embodiment of the present disclosure; and

FIG. 9 is a structure schematic diagram of an electronic device according to an embodiment of the present disclosure.

### DETAILED DESCRIPTION

It is to be understood that a plurality of steps in embodiments of a method according to the present disclosure may be performed in different sequences, and/or performed in parallel. Furthermore, the embodiments of the method may include additional steps and/or illustrated steps that are omitted to perform. The scope of the present disclosure is not limited in this respect.

The term “include” and its variations as used herein mean openly including, i.e. “including but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms are given in the following description.

It is to be noted that the concepts of “first”, “second”, etc. mentioned in the present disclosure are only used for distinguishing different apparatuses, modules or units, and are not to limit the function performing sequence or interdependence of these apparatuses, modules or units.

It is to be noted that the modifications of “one” and “plurality” mentioned in the present disclosure are schematic rather than restrictive, and those skilled in the art should understand that unless otherwise expressly indicated in the context, it should be understood as “one or more”.

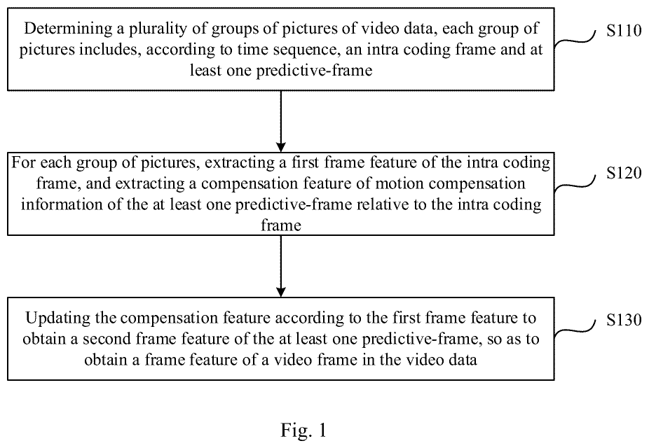

FIG. 1 is a flow schematic diagram of a feature extraction method for a video according to an embodiment of the present disclosure. This embodiment of the present disclosure is suitable for a situation of extracting video features, for example, a situation of extracting frame features of a plurality of video frames in video data coded according to a Moving Picture Experts Group (MPEG). The method may be executed by a feature extraction apparatus for a video, the apparatus may be realized in a form of software and/or hardware, and the apparatus can be configured in an electronic device, for example, a computer.

As shown in FIG. 1, the feature extraction method for the video according to this embodiment may include:

S110, determining a plurality of groups of pictures of video data, each group of pictures includes, according to time sequence, an intra coding frame and at least one predictive-frame.

In this embodiment, the video data may be data obtained by coding based on MPEG, for example, video data coded based on MPEG-4. The video data obtained by coding may include a plurality of Groups of Pictures (GOP), the first frame in each GOP may be an Intra Coding Frame (I-frame for short), and the frame following the first frame according to the time sequence may include at least one Predictive-frame (P-frame for short).

Exemplarily, the video data may be expressed with an equation V={Iᵢ, Pᵢ¹, Pᵢ², . . . , Pᵢ^{T}}ᵢ₌₁^{N}; in which, the video data V may be composed of N GOPs, and i may be the sequence number of the GOPs; and each GOP may include one I-frame and T P-frames.

The information in the I-frame may include coded complete image data. Exemplarily, when the I-frame is a three-channel RGB image, the I-frame may be represented as

$${I}_{i} ∈ {}^{3 \times H \times W} ;$$

the superscript 3×H×W may refer to that the number of channels of the image is 3, the height is H, and the width is W; and the contents of a plurality of parts in the superscript with identical format below can be referred to here, which are not be listed in the following.

The information in the P-frame may be motion compensation information. The motion compensation information may include information that describes the image difference between a current P-frame and the I-frame or the P-frame in the front in time sequence referred by this frame, for example, the motion compensation information may include information that describes that a target object of a front reference frame moves to a corresponding position in the current frame.

After the video data is acquired, the plurality of GOPs of the video data may be determined according to identifier information (such as the identifier information of the I-frame and the identifier information of the P-frame) carried by each frame in the video data. For example, it may be that when an I-frame identifier is identified, the corresponding frame of this identifier may be used as the first frame of one GOP until the last frame of the video data is identified, thus obtaining the plurality of GOPs of the video data.

S120, for each group of pictures, extracting a first frame feature of the intra coding frame, and extracting a compensation feature of motion compensation information of the at least one predictive-frame relative to the intra coding frame.

For each GOP, the I-frame in the GOP may be decoded to obtain the image data, and feature extraction may be performed on the image data of the decoded I-frame through an image feature extraction network (such as a convolutional neural network), so as to obtain a first frame feature of the I-frame. Exemplarily, the extraction process of the first frame feature may be represented with a formula X_{I}=F_{I}(I); in which I represents image data of the decoded I-frame; F_{I} (⋅) may represent the feature extraction network, for example, a residual network ResNet50; and X_{I} may represent a feature map of the first frame feature, and it may be

$${X}_{I} ∈ {}^{C \times H \times W} .$$

Because the P-frame in each GOP may be divided into a P-frame referencing the I-frame in the group and a P-frame referencing a forward P-frame in the group. In order to ensure the uniformity of the motion compensation information of the plurality of P-frames, the motion compensation information of the plurality of P-frames in the group relative to the I-frame in this group may be determined in advance.

In one embodiment, the motion compensation information of the plurality of predictive-frames relative to the intra coding frame may be determined based on the following steps: respectively taking at least one predictive-frame as a starting point to circularly determine the reference frame of the current frame forwards according to the time sequence, and taking the reference frame as a new current frame until the reference frame is the intra coding frame; accumulating the motion compensation information between the current frame and the reference frame in the circulation process; and when the circulation process is stopped, obtaining the motion compensation information of the at least one predictive-frame relative to the intra coding frame.

Exemplarily, the process of determining the motion compensation information of the P-frame relative to the I-frame in this group may include: firstly finding a pixel P′ of the reference frame of a pixel p forwards for the pixel p of the t^{th} P-frame in a certain GOP; then computing the motion compensation information of the pixel p relative to the pixel p′; and continuously querying the pixel of the reference frame forwards by taking the pixel p′ of the reference frame as a starting point, and performing accumulative updating of the motion compensation information on the basis of the previous motion compensation information until the reference frame is the I-frame of the current GOP. Therefore, the motion compensation information of the pixel p, relative to the corresponding pixel of the I-frame in this group, in the P-frame can be obtained through recursion.

In these embodiments, for each P-frame, the dependencies between the P-frames may be separated by forwards querying the reference frame and accumulating the motion compensation information until reaching the I-frame, each P-frame only depends on the reference I-frame and not other P-frames, thus ensuring the uniformity of the motion compensation information of at least one P-frame.

A lightweight feature extraction model may be used for extracting supplementary features of the motion compensation information of the at least one P-frame relative to I-frame in this group, so that the model computation time is saved. Exemplarily, the extraction process of the motion compensation features may be represented with a formula X_{C}^{t}=F_{C}(C^{t}); in the formula, C^{t} represents the motion compensation information of the t^{th} P-frame in the GOP relative to the I-frame in this group; F_{C}(⋅) may represent a lightweight feature extraction network, for example, a residual network ResNet18; X_{C}^{t} may represent a feature map of the compensation feature of the t^{th} P-frame in the GOP, and it may be

$${X}_{C}^{t} ∈ {}^{C \times H \times W} .$$

S130, updating the compensation feature according to the first frame feature to obtain a second frame feature of the at least one predictive-frame, so as to obtain a frame feature of a video frame in the video data.

Because the motion compensation information intrinsically does not include all information of the P-frame, part of the information of the P-frame needs to be obtained by depending on the information of the I-frame in this group. Because the motion compensation information of the plurality of P-frames in each GOP is different from the motion compensation information of the I-frame, part of features with high correlation degree with the plurality of P-frames may be selected from the first frame feature of the I-frame, and the compensation features of the plurality of P-frames are updated respectively.

For example, the process of updating the compensation feature of each P-frame may include: identifying an area, with high correlation degree with the plurality of P-frames, of the I-frame according to the motion compensation information of each P-frame relative to the I-frame in this group; for each P-frame, configuring the first frame feature corresponding to the area with the high correlation degree to be in a high weight, and configuring the first frame features corresponding to other areas to be in a low weight; and processing the first frame feature through the weight of the plurality of areas, and updating the compensation feature of each P-frame according to the processing result.

In this embodiment, for each GOP, the compensation features of the plurality of P-frames can be enriched through the first frame features of the I-frame in the group, and then the second frame features of the plurality of P-frames may be represented more accurately. Moreover, the frame features of the video frames of the plurality of GOPs may be extracted in parallel, and when the features of the I-frame and the P-frame in each GOP are determined, the frame feature of the video frame in the video data can be acquired. According to this embodiment, the video data does not need to be completely decoded, the features with relatively high accuracy of the I-frame and the P-frame can be determined only by decoding a small number of data of the I-frame, thus the storage space waste caused by decoding the plurality of frame data can be avoided, and the decoding time is greatly reduced.

In addition, after the frame feature of the video frame of the video data is extracted, the frame feature may also be applied to different service scenes, for example, service scenes such as video slicing, video editing, video understanding, video classification and video behavior recognition may be performed based on the frame feature, which are not listed here.

The technical solution of this embodiment of the present disclosure includes: determining the plurality of groups of pictures of video data, each group of pictures includes, according to the time sequence, the intra coding frame and the at least one predictive-frame; for each group of pictures, extracting the first frame feature of the intra coding frame, and extracting the compensation feature of the motion compensation information of the at least one predictive-frame relative to the intra coding frame; and updating the compensation feature according to the first frame feature to obtain the second frame feature of the at least one predictive-frame, so as to obtain the frame feature of the video frame in the video data. According to the feature extraction method, the plurality of video frames do not need to be completely decoded, the frame features of the plurality of video frames can be determined according to the information of the intra coding frame in the compressed and coded video data and the motion compensation information of the predictive-frame, thus the storage space can be saved, and the decoding time is reduced.

This embodiment of the present disclosure may be combined with a plurality of solutions in the feature extraction method for the video according to the embodiment above. According to the feature extraction method for the video according to this embodiment, the step of updating the compensation feature is described in detail. The feature expression of the compensation feature is enriched from the channel dimension and the spatial dimension by utilizing the first frame feature, so that more accurate and complete frame features of the predictive-frame can be acquired.

In one embodiment, the updating the compensation feature according to the first frame feature may include: splicing the first frame feature, the motion compensation information and the compensation feature to obtain a spliced image; determining a first weight of the spliced image in a channel dimension, and a second weight of the spliced image in a spatial dimension, respectively; and processing the first frame feature according to the first weight and the second weight to obtain an update parameter, and updating the compensation feature according to the update parameter.

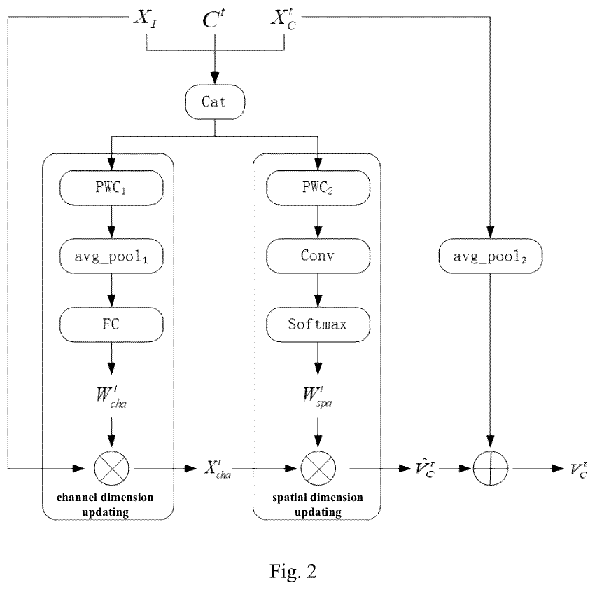

Exemplarily, FIG. 2 is a flow block diagram of updating a compensation feature in a feature extraction method for a video according to an embodiment of the present disclosure. As shown in FIG. 2, the first frame feature of the I-frame in the current GOP may be represented with X_{I}, which may be shown as

$${X}_{I} ∈ {}^{C \times H \times W} ;$$

the motion compensation information of the t^{th} P-frame in the current GOP may be represented with C^{t}, which may be shown as

$${C}^{t} ∈ {▯}^{d \times H \times W} ,$$

d may be a positive integer, and d of different types of motion compensation information may be different; and the compensation feature of the t^{th} P-frame in the current GOP may be represented with X_{C}^{t}, which may be shown as

$${X}_{C}^{t} ∈ {}^{C \times H \times W} .$$

X_{I}, C^{t} and X_{C}^{t} may be spliced (shown as Cat in the figure), and the size of the obtained spliced image may be shown as (2C+d)×H×W. The spliced image may be used as guide information and used for identifying an area, with high association degree with the t^{th} P-frame, of the I-frame in the current GOP. The area with the high association degree may be determined from the channel dimension and the spatial dimension respectively. For example, the first weight (shown as W_{cha}^{t} in the figure) in the channel dimension may be obtained by up-sampling the spliced image in the spatial dimension; and the second weight (shown as Wₛₚₐ^{t} in the figure) in the spatial dimension is obtained by up-sampling the spliced image in the channel dimension.

After the first weight and the second weight are determined, the first frame feature corresponding to the area with higher association degree may be extracted from the first frame feature according to the first weight and the second weight, thus obtaining the update parameter (shown as \hat{V}_{C}^{t} in the figure). Finally, the update parameter and the compensation feature X_{C}^{t} may be fused, and more accurate and complete second frame feature of the P-frame can be determined according to the fusion result.

In these embodiments, the feature expression of the compensation feature is enriched from the channel dimension and the spatial dimension through the first frame feature, and thus more accurate and complete frame feature of the predictive-frame can be acquired.

In one embodiment, the determining a first weight of the spliced image in a channel dimension, and a second weight of the spliced image in a spatial dimension, respectively, includes: extracting a splicing feature of the spliced image, the splicing feature and the first frame feature have an identical size; pooling the splicing feature in the spatial dimension, and performing full connection on the pooling result to obtain the first weight of the spliced image in the channel dimension; and performing convolution on the feature maps of a plurality of channels in the splicing feature, and performing logistic regression on the convolution result to obtain the second weight of the spliced image in the spatial dimension.

As shown in FIG. 2, the process of determining the first weight W_{cha}^{t} may include:

Firstly, extract a splicing feature with higher expression of the spliced image based on a lightweight feature extraction network (shown as PWC₁ in the figure). The step may be represented with a formula Z_{cha}^{t}=PWC₁([X₁; X_{C}^{t}; C^{t}]); in the formula, Z_{cha}^{t} can represent the splicing feature, it can be shown as

$${z}_{cha}^{t} ∈ {}^{C \times H \times W} ,$$

and the splicing feature has an identical size as the first frame feature; [X_{I}; X_{C}^{t}; C^{t}] can represent the spliced image; and PWC₁(⋅), for example, can be a 12-layer residual network.

Then, pool the spliced feature in the spatial dimension based on an average pooling network (shown as avg_pool₁ in the figure). The step may be represented with a formula h_{cha}^{t}=avg_pool₁(z_{cha}^{t}; and in the formula, h_{cha}^{t} can represent the average pooled splicing feature, and it can be shown as

$${h}_{cha}^{t} ∈ {}^{C} .$$

Finally, Connect the features of different channels based on a full connection network (shown as FC in the figure) to obtain the first weight W_{cha}^{t} of the spliced image in the channel dimension.

This step may be represented with a formula W_{cha}^{t}+σ(W₂·ζ(W₁h_{cha}^{t}+b₁)+b₂); in the formula,

$${W}_{c h a}^{t} ∈ {}^{C} ;$$

σ can represent an activation function, for example, a sigmod activation function; ζ can also represent the activation function, for example, a ReLU activation function; and W₁, b₁, W₂, b₂ can represent learnable parameters of the full-connection network, and these parameters can be obtained by pre-training. The first weight is a one-dimensional vector, and a plurality of element values in the vector can represent the importance degrees of the plurality of channels in the feature map of the first frame.

As shown in FIG. 2, the process of determining the second weight Wₛₚₐ^{t} may include:

Firstly, extract a splicing feature zₛₚₐ^{t} with higher expression of the spliced image based on a lightweight feature extraction network (shown as PWC₂ in the image). This step can refer to the step of determining z_{cha}^{t}, and the structures of the feature extraction networks used in the two steps may be identical or different.

Then, perform convolution on the feature maps of the plurality of channels in the splicing feature based on a convolutional network (shown as Conv in the map). This step may be represented with a formula hₛₚₐ^{t}=2d_conv(zₛₚₐ^{t}); in the formula, hₛₚₐ^{t} can represent the convolutional splicing feature, and

$${h}_{spa}^{t} ∈ {}^{H \times W} ;$$

and 2d_conv(⋅) can represent the convolutional network.

Finally, perform logistic regression on the convolution result based on a logistic regression function (such as a Softmax function in the figure) to obtain the second weight Wₛₚₐ^{t} of the spliced image in the spatial dimension. This step may be represented with a formula Wₛₚₐ^{t}=soft max(hₛₚₐ^{t}); and in the formula,

$${W}_{spa}^{t} ∈ {}^{H \times W} .$$

The second weight is a two-dimensional spatial weight map, and a plurality of element values in the weight map can represent the importance degrees of a plurality of areas in the feature map of the first frame.

In these embodiments, the features with higher expression can be obtained by extracting the splicing feature; pooling and full connection are carried out in the spatial dimension to obtain the first weight in the channel dimension; and a plurality of channels are subjected to convolution and logistic regression to obtain the second weight in the spatial dimension. Therefore, the area, with high correlation degree with the plurality of P-frames, of the feature map of the first frame of the I-frame in the GOP may be determined from the channel dimension and the spatial dimension respectively. In these optional embodiments, the processing the first frame feature according to the first weight and the second weight to obtain an update parameter includes: multiplying the first frame feature by the first weight and the second weight to obtain the update parameter.

In these embodiments, for the plurality of P-frames in each GOP, the first frame feature map may be multiplied by the corresponding first weight channel by channel to obtain a feature map after channel dimension updating; and then the feature map is multiplied by the corresponding second weight pixel by pixel to obtain a feature map after spatial dimension updating, thus obtaining the update parameter. Or, the first feature map may be multiplied by the corresponding second weight pixel by pixel to obtain the feature map after spatial dimension updating; and then the feature map is multiplied by the corresponding first weight channel by channel to obtain the feature map after channel dimension updating, thus obtaining the update parameter.

Exemplarily, the step of determining the update parameter of the t^{th} P-frame in each GOP may include:

Firstly, multiply the first frame feature map X_{I} by the first weight W_{cha}^{t} channel by channel through a formula X_{cha}^{t}=X_{I}⊗W_{cha}^{t}, so as to obtain a feature map X_{cha}^{t} after channel dimension updating.

Then, multiply X_{cha}^{t} by the second weight Wₛₚₐ^{t} pixel by pixel through a formula

$${\hat{V}}_{C}^{t} = {\sum }_{p = 1}^{H \cdot W} {X}_{c h a}^{t} {W}_{s p a}^{t} ,$$

so as to obtain a feature map \hat{V}_{C}^{t} after spatial dimension updating, thus obtaining an update parameter \hat{V}_{C}^{t}, and

$${\hat{V}}_{C}^{t} ∈ {}^{C} .$$

In the formula, P can represent the pixel sequence number, and the value range of p may be [1−H·W].

In one embodiment, the updating the compensation feature according to the update parameter includes: pooling the compensation feature in the spatial dimension, and adding the pooling result to the update parameter.

For the plurality of P-frames in each GOP, after the first frame feature is processed by the corresponding first weight in the channel dimension and the corresponding second weight in the spatial dimension, there may be a difference between the size of the update parameter and the size of the corresponding compensation feature. For example, the update parameter \hat{V}_{C}^{t} may be a one-dimensional C vector, and the compensation feature X_{C}^{t} may be a feature map with the size of C×H×W.

Exemplarily, as shown in FIG. 2, for the t^{th} P-frame in each GOP, the compensation feature X_{C}^{t} may be pooled in the spatial dimension through the average pooling network (shown as avg_pool₂ in the figure), and the pooling result is added to the update parameter \hat{V}_{C}^{t} to obtain the updated compensation feature. This step may be represented with a formula V_{C}^{t}=\hat{V}_{C}^{t}+avg_pool₂(X_{C}^{t}); and in the formula, V_{C}^{t} can represent the updated compensation feature, and

$${∇}_{C}^{t} ∈ {}^{C} .$$

In these embodiments, for the plurality of P-frames in each GOP, after corresponding update parameter and corresponding compensation feature are processed to be identical to the size, the update parameter and the compensation feature are added, thus the feature expression of the compensation feature can be enriched from the channel dimension and the spatial dimension, and more accurate and complete frame features of the plurality of P-frames can be acquired.

According to the technical solution of this embodiment of the present disclosure, the step of updating the compensation feature is described in detail. By utilizing the first frame feature to enrich the feature expression of the compensation feature from the channel dimension and the spatial dimension, the more accurate and complete frame feature of the predictive-frame can be acquired. In addition, the feature extraction method for the video according to this embodiment of the present disclosure belongs to the same disclosure conception as the feature extraction method for the video according to the above embodiments, and the technical details not described in detail in this embodiment can be referred to the above embodiments, and the same technical features have the same beneficial effect in this embodiment and in the above embodiments.

A plurality of solutions in the feature extraction method for the video according to this embodiment of the present disclosure and the above embodiments may be combined. According to the feature extraction method for the video in this embodiment, the step of determining the second frame feature of the predictive-frame is described in detail under the condition that the compensation information includes motion vectors and residuals. For any predictive-frame, an initial vector feature of the motion vectors and an initial residual feature of the residuals are updated according to the corresponding first frame feature, so that the target vector feature and the target residual feature with richer and more accurate feature expression can be acquired. Furthermore, the frame feature of the predictive-frame may be determined by combining the target vector feature and the target residual feature.

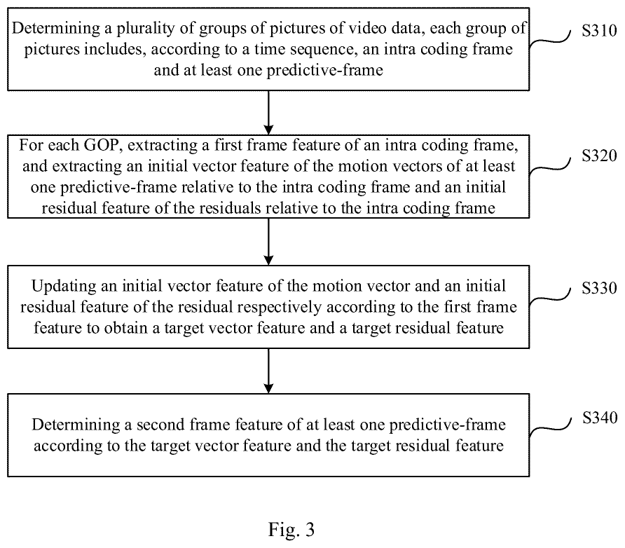

Exemplarily, FIG. 3 is a flow schematic diagram of a feature extraction method for a video according to another embodiment of the present disclosure. As shown in FIG. 3 a feature extraction method for a video according to this embodiment may include:

S310, determining a plurality of groups of pictures of video data, each group of pictures includes, according to a time sequence, an intra coding frame and at least one predictive-frame.

The motion compensation information of the P-frame may include but be not limited to Motion Vectors and Residuals. The motion vectors may record track information of a target object in the current P-frame relative to the object in the reference frame, and it may be represented with M^{t}, and M^{t}∈^{2×H×W}; the residuals can include rich boundary information of the target object, it may be represented with R^{t}, and R^{t}∈^{3×H×W}; and the superscript t may represent that the current P-frame is the t^{th} P-frame in relative GOP.

In this embodiment, the motion vectors and the residuals of the plurality of P-frames can be directly obtained from the coded video data, and the plurality of P-frames do not need to be decoded, so that the decoding time is greatly reduced.

S320, for each GOP, extracting a first frame feature of an intra coding frame, and extracting an initial vector feature of the motion vectors of at least one predictive-frame relative to the intra coding frame and an initial residual feature of the residuals relative to the intra coding frame.

For the t^{th} P-frame in each GOP, the motion compensation information includes the motion vectors M^{t} and the residuals R^{t}, and the compensation feature X_{C}^{t} of the motion compensation information can correspondingly include the initial vector feature X_{M}^{t} and the initial residual feature X_{R}^{t}. The process of extracting the initial vector feature X_{M}^{t} of the motion vectors and extracting the initial residual feature X_{R}^{t} of the residuals may refer to the process of extracting the compensation feature X_{C}^{t}, which is not listed here.

S330, updating an initial vector feature of the motion vector and an initial residual feature of the residual respectively according to the first frame feature to obtain a target vector feature and a target residual feature.

The process of for the t^{th} P-frame in each GOP, updating the initial vector feature X_{M}^{t} of the motion vectors according to the first frame feature X_{I} of the I-frame in relative group may include:
splicing the first frame feature X_{I}, the motion vectors Mt and the initial vector feature X_{M}^{t} to obtain a spliced image; determining the first weight W_{cha}^{t} of the spliced image in the channel dimension and the second weight Wₛₚₐ^{t}, in the spatial dimension, respectively; and processing the first frame feature X_{I} according to the first weight W_{cha}^{t} and the second weight Wₛₚₐ^{t}, to obtain an update parameter \hat{V}_{M}^{t}, and updating the initial vector feature X_{M}^{t} according to the update parameter \hat{V}_{M}^{t} to obtain a target vector feature V_{M}^{t}.

The process of for the t^{th} P-frame in each GOP, updating the initial residual feature X_{R}^{t} of the residuals according to the first frame feature X_{I} of the I-frame in relative group may include:
splicing the first frame feature X_{I}, the residuals R^{t} and the initial residual feature X_{R}^{t} to obtain a spliced image; determining the first weight W_{cha}^{t} of the spliced image in the channel dimension and the second weight Wₛₚₐ^{t}, in the spatial dimension, respectively; and processing the first frame feature X_{I} according to the first weight W_{cha}^{t} and the second weight Wₛₚₐ^{t} to obtain an update parameter \hat{V}_{R}^{t}, and updating the initial vector feature X_{R}^{t} according to the update parameter R to obtain a target vector feature V_{R}^{t}.

The process of updating the initial vector feature X_{M}^{t} and the initial residual feature X_{R}^{t} of the t^{th} P-frame in the group according to the first frame feature X_{I} of the I-frame may refer to the process of updating the compensation feature X_{C}^{t} according to the first frame feature X_{I} shown in FIG. 2, which is not listed here.

S340, determining a second frame feature of at least one predictive-frame according to the target vector feature and the target residual feature.

For the plurality of P-frames in each GOP, the weight sum of the corresponding target vector feature and the target residual feature may be used as the second frame feature. For example, for the t^{th} P-frame in the current GOP, the second frame feature \tilde{V}^{t} of the P-frame may be determined through a formula \tilde{V}=V_{M}^{t}+V_{R}^{t}, and

$${\tilde{V}}^{t} ∈ {□}^{C} .$$

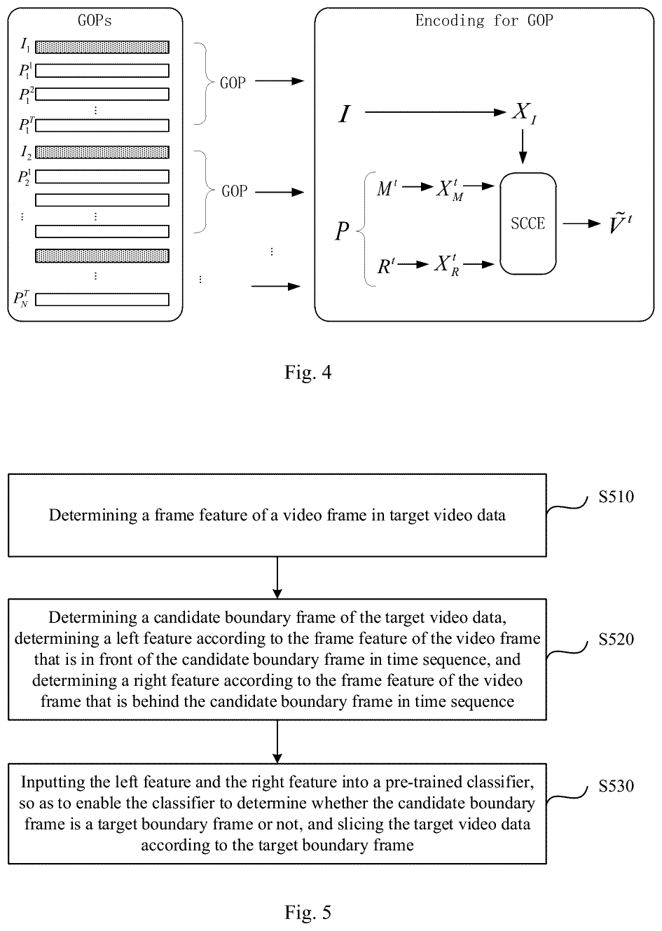

Exemplarily, FIG. 4 is a flow block diagram of a feature extraction method for a video according to an embodiment of the present disclosure. As shown in FIG. 4, the video data may be represented as GOPs, and the GOPs may include N GOPs. Each GOP may include one I-frame and T P-frames, the subscripts of the I-frame and the P-frames may represent the group sequence number of the GOPs, and the superscript of the P-frames may represent the sort of the P-frames in the plurality of P-frames in relative GOPs.

Each GOP can be inputted into a feature extraction module (shown as Encoding for GOP in the figure) in parallel for processing. For each GOP, the feature extraction module may extract the first frame feature X_{I} of the I-frame, and extract the initial vector feature X_{M}^{t} of the motion vectors M^{t} and the initial residual feature X_{R}^{t} of the residuals R^{t} in the plurality of P-frames. Then, the initial vector feature X_{M}^{t} and the initial residual feature X_{R}^{t} may be updated through a Spatial Channel Compressed Encoder (SCCE for short in the figure) to obtain the target vector feature V_{M}^{t} and the target vector feature V_{R}^{t} respectively, and the second frame feature \tilde{V}^{t} of the P-frame is determined according to the target vector feature V_{M}^{t} and the target vector feature V_{R}^{t}.

According to the technical solution of this embodiment of the present disclosure, the step of determining the second frame feature of the predictive-frame is described in detail under the condition that compensation information includes the motion vectors and the residuals. For any predictive-frame, the initial vector feature of the motion vectors and the initial residuals feature of the residuals are updated according to the corresponding first frame feature, and thus the target vector feature and the target residual feature with richer and more accurate feature expression can be acquired. Furthermore, the frame feature of the predictive-frame may be determined by combining the target vector feature and the target residual feature.

In addition, the feature extraction method for the video according to this embodiment of the present disclosure belongs to the same disclosure conception as the feature extraction method for the video according to the above embodiments, and the technical details not described in detail in this embodiment can be referred to the above embodiments, and the same technical features have the same beneficial effect in this embodiment and in the above embodiments.

FIG. 5 is a flow schematic diagram of a slicing method for a video according to an embodiment of the present disclosure. This embodiment of the present disclosure is suitable for a video slicing situation, such as the situation of slicing video data in an MPEG-4 coding format. This method may be executed by a slicing apparatus for a video, the apparatus may be realized in the form of software and/or hardware, and the apparatus can be configured in an electronic device, such as a computer.

As shown in FIG. 5, the slicing method for the video according to this embodiment may include:

S510, determining a frame feature of a video frame in target video data.

The frame features of a plurality of video frames may be extracted based on a method in related technology, or the frame features of the video frames in the target video data may also be determined according to any feature extraction method for the video according to the present disclosure, for example, the method may include:
determining a plurality of group of pictures of the target video data, each group of pictures includes, according to a time sequence, an intra coding frame and at least one predictive-frame; for each group of pictures, extracting the first frame feature of the intra coding frame, and extracting the compensation feature of the motion compensation information of the at least one predictive-frame relative to the intra coding frame; and updating the compensation feature according to the first frame feature to obtain the second frame feature of the at least one predictive frame, so as to obtain the frame feature of the video frame in the target video data.

When the frame features of the plurality of video frames are extracted based on the feature extraction method according to any embodiment of the present disclosure, the video frames do not need to be completely decoded, the beneficial effects of saving the storage space and reducing the decoding time can be realized, and the slicing efficiency can be improved on the decoding level.

In addition, there is a large amount of time sequence redundant information in the video information, which is challenging to video understanding. In order to extract the time sequence information, the slicing method for the video in the related technology usually adopts the optical flow information as additional input of a prediction network to improve the slicing precision. However, extraction of the optical flow information is very time-consuming and usually occupies more than 90% of the slicing time. The slicing method in the related technology can be considered to improve the slicing precision at the cost of high time consumption.

However, in the slicing method according to this embodiment, when the frame features of the plurality of video frames are extracted based on the feature extraction method according to any embodiment of the present disclosure, the compensation information in the P-frame can provide rich timing sequence information. By extracting the compensation feature and enriching the compensation feature in the channel dimension and the spatial dimension, the precision of the frame feature of the video frames may be improved, and then the slicing precision can be improved. Compared with the method in the related technology, the slicing precision can be ensured on the basis of time consumption reducing.

The updating the compensation feature according to the first frame feature may include: splicing the first frame feature, the motion compensation information and the compensation feature to obtain a spliced image; determining a first weight of the spliced image in the channel dimension, and a second weight of the spliced image in the spatial dimension, respectively; and processing the first frame feature according to the first weight and the second weight to obtain an update parameter, and updating the compensation feature according to the update parameter.

The determining a first weight of the spliced image in the channel dimension and a second weight in the spatial dimension, respectively, may include: extracting a splicing feature of the spliced image, the splicing feature and the first frame feature have an identical size; pooling the splicing features in the spatial dimension, and performing full connection on the pooling result, so as to obtain the first weight of the spliced image in the channel dimension; and performing convolution on the feature maps of a plurality of channels in the splicing feature, and performing logistic regression on the convolution result, so as to obtain the second weight of the spliced image in the spatial dimension.

The processing the first frame feature according to the first weight and the second weight to obtain an update parameter may include: multiplying the first frame feature by the first weight and the second weight to obtain the update parameter.

The updating the compensation feature according to the update parameter may include: pooling the compensation feature in the spatial dimension, and adding the pooling result to the update parameter.

The motion compensation information includes the motion vectors and residuals; and the updating the compensation feature according to the first frame feature to obtain a second frame feature of at least one predictive-frame may include: updating an initial vector feature of the motion vector and an initial residual feature of the residual respectively according to the first frame feature to obtain a target vector feature and a target residual feature; and determining the second frame feature of the predictive-frame according to the target vector feature and the target residual feature.

The motion compensation information of the predictive-frame relative to the intra coding frame is determined based on the following steps: respectively taking at least one predictive-frame as a starting point to circularly determine the reference frame of the current frame forwards according to the time sequence, and taking the reference frame as a new current frame until the reference frame is the intra coding frame; accumulating the motion compensation information between the current frame and the reference frame in the circulation process; and when the circulation process is stopped, obtaining the motion compensation information of the at least one predictive-frame relative to the intra coding frame.

In one embodiment, the target video data includes a plurality of groups of pictures, each group of pictures includes, according to the time sequence, an intra coding frame and at least one predictive-frame, and the determining the frame feature of the video frame in the target video data may include: for each group of pictures, determining the first frame feature of the intra coding frame and the second frame feature of the at least one predictive-frame; and performing size transformation on the first frame feature so as to enable the size of the first frame feature after size transformation to be identical to a size of the second frame feature.

The first frame feature may be a feature map representing the I-frame, and the second frame feature may be a feature vector representing the P-frame information; and in order to enable the plurality of frame features to have comparability, may perform size transformation on the first frame feature so as to enable the size of the first frame feature after the size transformation to be identical to the size of the second frame feature. For example, the first frame feature with large size may be subjected to up-sampling, pooling and other modes to achieve size dimension reduction and diminishing, thus obtaining the feature with identical size of the second frame feature.

In addition, the second frame feature may also be subjected to size dimension increase and expansion, so that the second frame feature is the same as the first frame feature in size, and the plurality of frame features have comparability. However, this mode may cause increase of the subsequent computation amount, so the first frame feature may be processed to be identical to the size of the second frame feature.

In these embodiments, the I-frame feature and the P-frame feature are processed to be identical to the size, thus the plurality of frame features may have comparability, which is conducive to the realization of boundary frame recognition operations.

S520, determining a candidate boundary frame of the target video data, determining a left feature according to the frame feature of the video frame that is in front of the candidate boundary frame in time sequence, and determining a right feature according to the frame feature of the video frame that is behind the candidate boundary frame in time sequence.

When determining the candidate boundary frame, a plurality of frames of the target video data can be used as the candidate boundary frames, or at least one candidate boundary frame may be obtained through random sampling, or the candidate boundary frame may be determined in other modes, which is not listed here.

For any candidate boundary frame, the left feature may be determined according to the frame features of k₁ video frames which are in front of the current frame in time sequence, and the right feature may be determined according to the frame features of k₂ video frames which are behind the current frame in time sequence. The values of k₁ and k₂ may be determined according to empirical values or experimental values, for example, they both may be 3. When determining the left and right features, the maximum value, the minimum value or the average value in the frame features of previous k₁ video frames may be used as the left feature; the maximum value, the minimum value or the average value in the frame features of later k₂ video frames can be used as the right feature; and the determination modes of the left and right features are generally consistent.

In one embodiment, the left feature is obtained by weighted sum of the frame features of the video frames that are in front of the candidate boundary frame in time sequence; and the right feature is obtained by weighted sum of the frame features of the video frames that are behind the candidate boundary frame in time sequence.

Exemplarily, the step of determining the left feature may be represented through a formula

$${ϕ}^{l} = {\sum }_{j = 1}^{{k}_{1}} {W}_{j} {\tilde{V}}^{l - j} ;$$

in the formula, l can represent the frame number of the current candidate boundary frame; ϕ^{l} can represent the left feature of the current candidate boundary frame; l-j can represent the frame number of the previous j^{th} video frame of the current candidate boundary frame, and the value range of J may be [1,k1]; \tilde{V}^{l-j} can represent the frame feature of the previous j^{th} video frame of the current candidate boundary frame; and Wⱼ can represent the weight of the frame feature of the previous j^{th} video frame of the current candidate boundary frame. Wⱼ represent learnable parameters, and

$${W}_{j} ∈ {}^{C} .$$

The step of determining the right feature may be represented through a formula

$${ψ}^{l} = {\sum }_{j = 1}^{{k}_{2}} {W}_{j} {\tilde{V}}^{l + j} ;$$

in the formula, l can represent the frame number of the current candidate boundary frame; ψ^{l} can represent the right feature of the current candidate boundary frame; l+j can represent the frame number of the later j^{th} video frame of the current candidate boundary frame, and the value range of j may be [1,k2]; \tilde{V}^{l+j} can represent the frame feature of the later j^{th} video frame of the current candidate boundary frame; and Wⱼ can represent the weight of the frame feature of the later j^{th} video frame of the current candidate boundary frame. Wⱼ represents the learnable parameters, and

$${W}_{j} ∈ {}^{C} .$$

In these embodiments, the weighted sum of the frame features may be effectively realized by a dimension convolution operation to obtain the left feature and the right feature.

S530, inputting the left feature and the right feature into a pre-trained classifier, so as to enable the classifier to determine whether the candidate boundary frame is a target boundary frame or not, and slicing the target video data according to the target boundary frame.

The left feature and the right feature may be inputted into the classifier, or the left feature and the right feature may also be connected according to a preset rule and then inputted into the classifier. For example, the right feature ψ^{l} can be connected to the left feature ϕ^{l} through [ϕ^{l}; ψ^{l}]. After the classifier determines the left feature and the right feature of the current candidate frame, the left feature and the right feature may be subjected to feature comparison to determine whether the current candidate boundary frame is the target boundary frame or not. And then, the target video data may be sliced by taking the target boundary frame as a slicing position.

Compared with the slicing method in the related technology, the slicing method according to this embodiment of the present disclosure has at least the following advantages:

1. According to the slicing method in the related technology, a video slicing task is generally defined as a binary classification task, namely whether each inputted frame is a boundary or not is predicted. In order to consider the context information of the time domain, the front and back preset frames (such as the front and back 5 frames) of each frame will be inputted into the prediction network. The prediction network will predict whether the frame is the boundary or not after extracting the features of the inputted frames. Thus, a large amount of redundant computation will be introduced, resulting in low slicing efficiency.

However, in the slicing method according to this embodiment, after the frame features of the video frame is extracted, the subsequent prediction operation on the candidate video frame can be performed on the basis of these frame features, thus a large amount of redundant computation is eliminated, the slicing efficiency can be improved on the model level, the prediction time is greatly reduced, and real-time slicing can be achieved.

2. In the slicing method in the related technology, in order to accurately predict the boundary position of slicing, the features of every two adjacent frames need to be compared, and the discrimination mode is very low in efficiency. However, in the slicing method according to this embodiment, the left and right features of the candidate boundary frame are divided, and the boundary is predicted according to the left and right features, so information with high discrimination may be provided for boundary prediction, and the discrimination mode is more efficient and flexible.

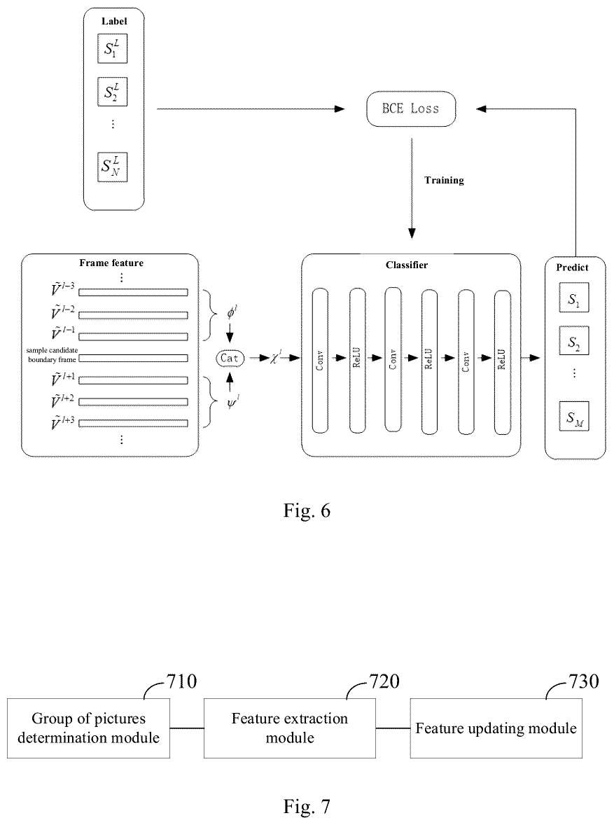

FIG. 6 is a flow block diagram of a training classifier in a slicing method for a video according to an embodiment of the present disclosure. As shown in FIG. 6, in one embodiment, the classifier can be trained based on the following steps:

Firstly, according to any feature extraction method for the video according to the present disclosure, determine the frame feature of the video frame in sample video data, and determine boundary frame labels (such as S₁^{L}, S₂^{L}, . . . , S_{N}^{L} in the figure) of the sample video data.

Secondly, determine the sample candidate boundary frame of the sample video data, determine the sample left feature ϕ^{l} according to the frame feature (such as \tilde{V}^{l-1}, \tilde{V}^{l-2}, \tilde{V}^{l-3} in the figure) of the video frame that is in front of the sample candidate boundary frame in time sequence, and determine a sample right feature ψ^{l} according to the frame feature (such as \tilde{V}^{l+1}, \tilde{V}^{l+2}, \tilde{V}^{l+3} in the figure) of the video frame that is behind the sample candidate boundary frame in time sequence.

Thirdly, input the sample left feature and the sample right feature into the classifier, so as to enable the classifier to determine whether the sample candidate boundary frame is a sample target boundary frame or not. For example, the sample left feature ϕ^{l} and the sample right feature Ω(shown as cat in the figure) are connected to obtain a feature χ^{l}; χ^{l} is inputted into the classifier, and the sample target boundary frame (such as S₁, S₂, . . . , S_{M} in the figure) is predicted through a plurality of convolution layers (Cony in the figure) and a plurality of activation layers (ReLU in the figure) in the classifier.

Fourthly, train the classifier according to the sample target boundary frame and the boundary frame labels determined by the classifier. For example, the loss value of S₁, S₂, . . . , S_{M} and S₁^{L}, S₂^{L}, . . . , S_{N}^{L} may be solved through a loss function, and the parameters of a plurality of network layers in the classifier are adjusted according to the loss value, thus realizing the training of the classifier. The loss function may be a Binary Cross Entropy loss (BCE loss) function in the figure, and may also be other loss functions for the classifier.

Whether the candidate boundary frame is the target boundary frame or not may be determined through the trained classifier according to the inputted left feature and right feature of the candidate boundary frame.

According to the technical solution of this embodiment of the present disclosure, any feature extraction method for the video according to this embodiment of the present disclosure includes: determining the frame feature of the video frame in target video data; determining the candidate boundary frame of the target video data, determining the left feature according to the frame feature of the video frame that is in front of the candidate boundary frame in time sequence, and determining the right feature according to the frame feature of the video frame that is behind the candidate boundary frame in time sequence; and inputting the left feature and the right feature into a pre-trained classifier, so as to enable the classifier to determine whether the candidate boundary frame is the target boundary frame or not, and slicing the target video data according to the target boundary frame.

According to the slicing method, the beneficial effects of saving the storage space and reducing the decoding time can be achieved, and instead of repeatedly extracting the feature of the video frame, the whole segment of target video data is used as the input to determine the frame features of the plurality of video frames. These frame features can be shared subsequently to perform boundary frame prediction, so that a large amount of redundant computation is eliminated, and the slicing efficiency is improved. Besides, compared with the related technology that boundary prediction is performed according to the frame features of the inputted frames, the method according to the present disclosure divides the left feature and the right feature of the candidate boundary frame, and predicts the boundary according to the left feature and the right feature, thus information with higher discrimination can be provided for boundary prediction, and the discrimination accuracy is improved.

In addition, the slicing method for the video according to this embodiment of the present disclosure belongs to the same disclosure conception as the feature extraction method for the video according to the above embodiments, and the technical details not described in detail in this embodiment can be referred to the above embodiments, and the same technical features have the same beneficial effect in this embodiment and in the above embodiments.

FIG. 7 is a structure schematic diagram of a feature extraction apparatus for a video according to an embodiment of the present disclosure. The feature extraction apparatus for the video according to this embodiment is suitable for the situation of extracting video features, such as the situation of extracting the frame feature of the video frame in video data coded according to MPEG-4.

As shown in FIG. 7, the feature extraction apparatus for the video according to this embodiment may include: a group of pictures determination module 710, a feature extraction module 720, and a feature updating module 730;
the group of pictures determination module 710 is configured to determine a plurality of groups of pictures of video data, in which each group of pictures includes, according to a time sequence, an intra coding frame and at least one predictive-frame;
the feature extraction module 720 is configured to, for each group of pictures, extract a first frame feature of the intra coding frame, and extract a compensation feature of motion compensation information of the at least one predictive-frame relative to the intra coding frame; and
the feature updating module 730 is configured to the compensation feature according to the first frame feature to obtain a second frame feature of the at least one predictive-frame, so as to obtain a frame feature of a video frame in the video data.

In an embodiment, the feature updating module may be configured to:
splice the first frame feature, the motion compensation information and the compensation feature to obtain a spliced image;
determine a first weight of the spliced image in a channel dimension, and a second weight of the spliced image in a spatial dimension, respectively;
process the first frame feature according to the first weight and the second weight to obtain an update parameter, and update the compensation feature according to the update parameter.

In an embodiment, the feature updating module may be configured to:
extract a splicing feature of the spliced image, in which the splicing feature and the first frame feature have an identical size;
pool the splicing feature in the spatial dimension, and perform full connection on a pooling result to obtain the first weight of the spliced image in the channel dimension; and
perform convolution on feature maps of a plurality of channels in the splicing feature, and perform logistic regression on a convolution result to obtain the second weight of the spliced image in the spatial dimension.

In an embodiment, the feature updating module may be configured to:
multiply the first frame feature by the first weight and the second weight to obtain the update parameter.

In an embodiment, the feature updating module may be configured to:
pool the compensation feature in the spatial dimension, and add a pooling result to the update parameter.

In an embodiment, the motion compensation information includes a motion vector and a residual;
the feature updating module may be configured to:
update an initial vector feature of the motion vector and an initial residual feature of the residual respectively according to the first frame feature to obtain a target vector feature and a target residual feature;
determine the second frame feature of the at least one predictive-frame according to the target vector feature and the target residual feature.

In an embodiment, the feature extraction apparatus may further include: a motion compensation information determination module;
the motion compensation information determination module may be configured to determine the motion compensation information of the at least one predictive-frame relative to the intra coding frame based on the following steps:
respectively taking the at least one predictive-frame as a starting point to circularly determine a reference frame of a current frame forwards according to the time sequence, and taking the reference frame as a new current frame until the reference frame is the intra coding frame;
accumulating motion compensation information between the current frame and the reference frame in a circulation process;
obtaining, when the circulation process is stopped, the motion compensation information of the at least one predictive-frame relative to the intra coding frame.

The feature extraction apparatus for the video according to this embodiment of the present disclosure may perform the feature extraction method for the video according to any embodiment of the present disclosure, and has functional modules and beneficial effects of executing the method.

It is to be noted that the plurality of units and modules in the above-mentioned apparatus are only divided according to functional logic, but are not limited to the above-mentioned division, as long as the corresponding functions can be realized; and moreover, the specific names of the plurality of functional units are only for the convenience of distinguishing them from each other and are not used to limit the scope of protection of the embodiments of the present disclosure.

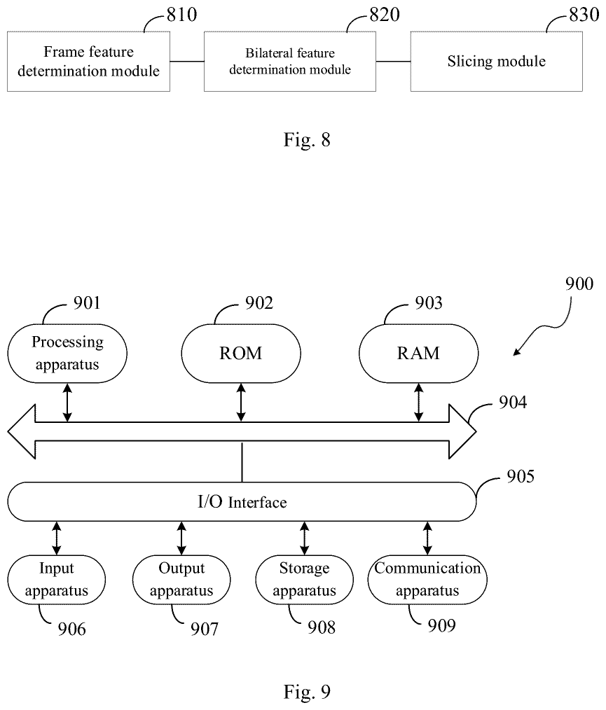

FIG. 8 is a structure schematic diagram of a slicing apparatus for a video according to an embodiment of the present disclosure. The slicing apparatus for the video according to this embodiment is suitable for a situation of video slicing, for example, the situation of slicing video data in an MPEG-4 coding format.

As shown in FIG. 8, the slicing apparatus for the video provided by this embodiment may include: a frame feature determination module 810, a bilateral feature determination module 820 and a slicing module 830;
the frame feature determination module 810 is configured to determine a frame feature of a video frame in target video data;
the bilateral feature determination module 820 is configured to determine a candidate boundary frame of the target video data, determine a left feature according to a frame feature of a video frame that is in front of the candidate boundary frame in a time sequence, and determine a right feature according to a frame feature of a video frame that is behind the candidate boundary frame in the time sequence;
the slicing module 830 is configured to input the left feature and the right feature into a pre-trained classifier, so as to enable the classifier to determine whether the candidate boundary frame is a target boundary frame or not, and slicing the target video data according to the target boundary frame.

The frame feature determination module 810 may be configured to determine the frame feature of the video frame in the target video data according to the feature extraction method for video of any of the embodiments of the present disclosure.

In an embodiment, the target video data includes a plurality of groups of pictures, each group of pictures includes, according to the time sequence, an intra coding frame and at least one predictive-frame, and the frame feature determination module may be configured to:
for each group of pictures, determine a first frame feature of the intra coding frame and a second frame feature of the at least one predictive-frame; and
perform size transformation on the first frame feature so as to enable a size of the first frame feature after the size transformation to be identical to a size of the second frame feature.

In an embodiment, the left feature is obtained by a weighted sum of frame features of video frames in front of the candidate boundary frame in the time sequence, and the right feature is obtained by a weighted sum of frame features of video frames behind the candidate boundary frame in the time sequence.

In an embodiment, the frame feature determination module may further be configured to determine the frame feature of the video frame in sample video data, and determine a boundary frame label of the sample video data, according to the feature extraction method for the video of any of the embodiments of the present disclosure;
the bilateral feature determination module may further configurable to determine a sample candidate boundary frame of the sample video data, determining a sample left feature according to a frame feature of a video frame that is in front of the sample candidate boundary frame in the time sequence, and determine a sample right feature according to a frame feature of a video frame that is behind the sample candidate boundary frame in the time sequence;
the slicing module may further be configured to input the sample left feature and the sample right feature into the classifier, so as to enable the classifier to determine whether the sample candidate boundary frame is a sample target boundary frame or not;
the slicing module may further include: a classifier training module, the classifier training module is configured to train the classifier according to the sample target boundary frame determined by the classifier and the boundary frame label.

The slicing apparatus for the video provided in the embodiments of the present disclosure may execute the slicing method for the video provided in any embodiment of the present disclosure, with the functional modules and beneficial effects corresponding to the execution of the method.

It is worth noting that the plurality of units and modules included in the above apparatus are only divided according to functional logic, but are not limited to the above division, as long as the corresponding functions can be realized; furthermore, the specific names of the plurality of functional units are only for the purpose of facilitating differentiation from each other, and are not used to limit the scope of protection of the embodiments of the present disclosure.

Referring to FIG. 9, FIG. 9 illustrates a schematic structural diagram of an electronic device 900 (For example, the terminal device or server in FIG. 9) suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Usually, the following apparatus may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 9 illustrates the electronic device 900 having various apparatuses, it should be understood that not all of the illustrated apparatuses are necessarily implemented or included. More or fewer apparatuses may be implemented or included alternatively.

According to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

The electronic device according to this embodiment of the present disclosure belongs to the same disclosure conception as the feature extraction method for the video and the slicing method for the video according to the above embodiments, and the technical details not described in detail in this embodiment can be referred to the above embodiments, and the same technical features have the same beneficial effect in this embodiment and in the above embodiments.

An embodiment of the present disclosure provides a computer storage medium on which a computer program is stored; and when the program is executed by a processor, the feature extraction method for the video or the slicing method for the video according to the above embodiment is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
determine a plurality of groups of pictures of video data, in which each group of pictures includes, according to a time sequence, an intra coding frame and at least one predictive-frame; for each group of pictures, extract a first frame feature of the intra coding frame, and extract a compensation feature of motion compensation information of the at least one predictive-frame relative to the intra coding frame; update the compensation feature according to the first frame feature to obtain a second frame feature of the at least one predictive-frame, so as to obtain a frame feature of a video frame in the video data.

Or, the electronic device is caused to:
determine a frame feature of a video frame in target video data; determine a candidate boundary frame of the target video data, determine a left feature according to a frame feature of a video frame that is in front of the candidate boundary frame in a time sequence, and determine a right feature according to a frame feature of a video frame that is behind the candidate boundary frame in the time sequence; input the left feature and the right feature into a pre-trained classifier, so as to enable the classifier to determine whether the candidate boundary frame is a target boundary frame or not, and slicing the target video data according to the target boundary frame.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, [Example 1] provides a feature extraction method for the video, and the method includes:
determining a plurality of groups of pictures of video data, in which each group of pictures includes, according to a time sequence, an intra coding frame and at least one predictive-frame;
for each group of pictures, extracting a first frame feature of the intra coding frame, and extracting a compensation feature of motion compensation information of the at least one predictive-frame relative to the intra coding frame; and
updating the compensation feature according to the first frame feature to obtain a second frame feature of the at least one predictive-frame, so as to obtain a frame feature of a video frame in the video data.

According to one or more embodiments of the present disclosure, [Example 2] provides a feature extraction method for the video, updating the compensation feature according to the first frame feature, includes:
splicing the first frame feature, the motion compensation information and the compensation feature to obtain a spliced image;
determining a first weight of the spliced image in a channel dimension, and a second weight of the spliced image in a spatial dimension, respectively; and
processing the first frame feature according to the first weight and the second weight to obtain an update parameter, and updating the compensation feature according to the update parameter.

According to one or more embodiments of the present disclosure, [Example 3] provides a feature extraction method for the video, determining the first weight of the spliced image in the channel dimension, and the second weight of the spliced image in the spatial dimension, respectively, includes:
extracting a splicing feature of the spliced image, in which the splicing feature and the first frame feature have an identical size;
pooling the splicing feature in the spatial dimension, and performing full connection on a pooling result to obtain the first weight of the spliced image in the channel dimension; and
performing convolution on feature maps of a plurality of channels in the splicing feature, and performing logistic regression on a convolution result to obtain the second weight of the spliced image in the spatial dimension.

According to one or more embodiments of the present disclosure, [Example 4] provides a feature extraction method for the video, in which processing the first frame feature according to the first weight and the second weight to obtain the update parameter, includes:
multiplying the first frame feature by the first weight and the second weight to obtain the update parameter.

According to one or more embodiments of the present disclosure, [Example 5] provides a feature extraction method for the video, in which updating the compensation feature according to the update parameter, includes:
pooling the compensation feature in the spatial dimension, and adding a pooling result to the update parameter.

According to one or more embodiments of the present disclosure, [Example 6] provides a feature extraction method for the video, in which the motion compensation information includes a motion vector and a residual;
updating the compensation feature according to the first frame feature to obtain the second frame feature of the at least one predictive-frame, includes:
updating an initial vector feature of the motion vector and an initial residual feature of the residual respectively according to the first frame feature to obtain a target vector feature and a target residual feature; and
determining the second frame feature of the at least one predictive-frame according to the target vector feature and the target residual feature.

According to one or more embodiments of the present disclosure, [Example 7] provides a feature extraction method for the video, in which the motion compensation information of the at least one predictive-frame relative to the intra coding frame is determined based on following steps:

respectively taking the at least one predictive-frame as a starting point to circularly determine a reference frame of a current frame forwards according to the time sequence, and taking the reference frame as a new current frame until the reference frame is the intra coding frame;
accumulating motion compensation information between the current frame and the reference frame in a circulation process; and
obtaining, when the circulation process is stopped, the motion compensation information of the at least one predictive-frame relative to the intra coding frame.

According to one or more embodiments of the present disclosure, [Example 8] provides a slicing method for the video, and the method includes:
determining a frame feature of a video frame in target video data;
determining a candidate boundary frame of the target video data, determining a left feature according to a frame feature of a video frame that is in front of the candidate boundary frame in a time sequence, and determining a right feature according to a frame feature of a video frame that is behind the candidate boundary frame in the time sequence; and
inputting the left feature and the right feature into a pre-trained classifier, so as to enable the classifier to determine whether the candidate boundary frame is a target boundary frame or not, and slicing the target video data according to the target boundary frame.

According to one or more embodiments of the present disclosure, [Example 9] provides a slicing method for the video, in which the target video data includes a plurality of groups of pictures, each group of pictures includes, according to the time sequence, an intra coding frame and at least one predictive-frame, and determining the frame feature of the video frame in the target video data includes:
for each group of pictures, determining a first frame feature of the intra coding frame and a second frame feature of the at least one predictive-frame; and
performing size transformation on the first frame feature so as to enable a size of the first frame feature after the size transformation to be identical to a size of the second frame feature.

According to one or more embodiments of the present disclosure, [Example 10] provides a slicing method for the video, in which the left feature is obtained by a weighted sum of frame features of video frames in front of the candidate boundary frame in the time sequence, and the right feature is obtained by a weighted sum of frame features of video frames behind the candidate boundary frame in the time sequence.

According to one or more embodiments of the present disclosure, [Example 11] provides a slicing method for the video, in which the classifier is trained based on the following steps:
determining the frame feature of the video frame in sample video data, and determining a boundary frame label of the sample video data;
determining a sample candidate boundary frame of the sample video data, determining a sample left feature according to a frame feature of a video frame that is in front of the sample candidate boundary frame in the time sequence, and determining a sample right feature according to a frame feature of a video frame that is behind the sample candidate boundary frame in the time sequence;
inputting the sample left feature and the sample right feature into the classifier, so as to enable the classifier to determine whether the sample candidate boundary frame is a sample target boundary frame or not; and
training the classifier according to the sample target boundary frame determined by the classifier and the boundary frame label.

Furthermore, while a plurality of operations are depicted using a particular order, this should not be construed as requiring that the operations be performed in the particular order shown or in a sequential order of execution. Multi-tasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, a plurality of features described in the context of a single embodiment may also be implemented in multiple embodiments, either individually or in any suitable sub-combination.

1. A feature extraction method for a video, comprising:
determining a plurality of groups of pictures of video data, wherein each group of pictures comprises, according to a time sequence, an intra coding frame and at least one predictive-frame;
for each group of pictures, extracting a first frame feature of the intra coding frame, and extracting a compensation feature of motion compensation information of the at least one predictive-frame relative to the intra coding frame; and
updating the compensation feature according to the first frame feature to obtain a second frame feature of the at least one predictive-frame, so as to obtain a frame feature of a video frame in the video data.

2. The method according to claim 1, wherein updating the compensation feature according to the first frame feature, comprises:
splicing the first frame feature, the motion compensation information and the compensation feature to obtain a spliced image;
determining a first weight of the spliced image in a channel dimension, and a second weight of the spliced image in a spatial dimension, respectively; and
processing the first frame feature according to the first weight and the second weight to obtain an update parameter, and updating the compensation feature according to the update parameter.

3. The method according to claim 2, wherein determining the first weight of the spliced image in the channel dimension, and the second weight of the spliced image in the spatial dimension, respectively, comprises:
extracting a splicing feature of the spliced image, wherein the splicing feature and the first frame feature have an identical size;
pooling the splicing feature in the spatial dimension, and performing full connection on a pooling result to obtain the first weight of the spliced image in the channel dimension; and
performing convolution on feature maps of a plurality of channels in the splicing feature, and performing logistic regression on a convolution result to obtain the second weight of the spliced image in the spatial dimension.

4. The method according to claim 2, wherein processing the first frame feature according to the first weight and the second weight to obtain the update parameter, comprises:
multiplying the first frame feature by the first weight and the second weight to obtain the update parameter.

5. The method according to claim 2, wherein updating the compensation feature according to the update parameter, comprises:
pooling the compensation feature in the spatial dimension, and adding a pooling result to the update parameter.

6. The method according to claim 1, wherein the motion compensation information comprises a motion vector and a residual; and
updating the compensation feature according to the first frame feature to obtain the second frame feature of the at least one predictive-frame, comprises:
updating an initial vector feature of the motion vector and an initial residual feature of the residual respectively according to the first frame feature to obtain a target vector feature and a target residual feature; and
determining the second frame feature of the at least one predictive-frame according to the target vector feature and the target residual feature.

7. The method according to claim 1, wherein the motion compensation information of the at least one predictive-frame relative to the intra coding frame is determined based on following steps:
respectively taking the at least one predictive-frame as a starting point to circularly determine a reference frame of a current frame forwards according to the time sequence, and taking the reference frame as a new current frame until the reference frame is the intra coding frame;
accumulating motion compensation information between the current frame and the reference frame in a circulation process; and
obtaining, when the circulation process is stopped, the motion compensation information of the at least one predictive-frame relative to the intra coding frame.

8. A slicing method for a video, comprising:
determining a frame feature of a video frame in target video data;
determining a candidate boundary frame of the target video data, determining a left feature according to a frame feature of a video frame that is in front of the candidate boundary frame in a time sequence, and determining a right feature according to a frame feature of a video frame that is behind the candidate boundary frame in the time sequence; and
inputting the left feature and the right feature into a pre-trained classifier, so as to enable the classifier to determine whether the candidate boundary frame is a target boundary frame or not, and slicing the target video data according to the target boundary frame.

9. The method according to claim 8, wherein the target video data comprises a plurality of groups of pictures, each group of pictures comprises, according to the time sequence, an intra coding frame and at least one predictive-frame, and determining the frame feature of the video frame in the target video data comprises:
for each group of pictures, determining a first frame feature of the intra coding frame and a second frame feature of the at least one predictive-frame; and
performing size transformation on the first frame feature so as to enable a size of the first frame feature after the size transformation to be identical to a size of the second frame feature.

10. The method according to claim 8, wherein the left feature is obtained by a weighted sum of frame features of video frames in front of the candidate boundary frame in the time sequence, and the right feature is obtained by a weighted sum of frame features of video frames behind the candidate boundary frame in the time sequence.

11. The method according to claim 8, wherein the classifier is trained based on following steps:
determining the frame feature of the video frame in sample video data, and determining a boundary frame label of the sample video data;
determining a sample candidate boundary frame of the sample video data, determining a sample left feature according to a frame feature of a video frame that is in front of the sample candidate boundary frame in the time sequence, and determining a sample right feature according to a frame feature of a video frame that is behind the sample candidate boundary frame in the time sequence;
inputting the sample left feature and the sample right feature into the classifier, so as to enable the classifier to determine whether the sample candidate boundary frame is a sample target boundary frame or not; and
training the classifier according to the sample target boundary frame determined by the classifier and the boundary frame label.

12. (canceled)

13. (canceled)

14. An electronic device, comprising:
at least one processor; and
a storage apparatus, configured to store at least one program,
wherein the at least one program, when executed by the at least one processor, causes the at least one processor to implement a feature extraction method for a video, which comprises:
determining a plurality of groups of pictures of video data, wherein each group of pictures comprises, according to a time sequence, an intra coding frame and at least one predictive-frame; for each group of pictures, extracting a first frame feature of the intra coding frame, and extracting a compensation feature of motion compensation information of the at least one predictive-frame relative to the intra coding frame; and updating the compensation feature according to the first frame feature to obtain a second frame feature of the at least one predictive-frame, so as to obtain a frame feature of a video frame in the video data; or
wherein the at least one program, when executed by the at least one processor, causes the at least one processor to implement a slicing method for a video, which comprises:
determining a frame feature of a video frame in target video data; determining a candidate boundary frame of the target video data, determining a left feature according to a frame feature of a video frame that is in front of the candidate boundary frame in a time sequence, and determining a right feature according to a frame feature of a video frame that is behind the candidate boundary frame in the time sequence; and inputting the left feature and the right feature into a pre-trained classifier, so as to enable the classifier to determine whether the candidate boundary frame is a target boundary frame or not, and slicing the target video data according to the target boundary frame.

15. A storage medium comprising computer-executable instructions, wherein the computer-executable instructions, when executed by a computer processor, are used to perform the feature extraction method for the video according to claim 1.

16. A storage medium comprising computer-executable instructions, wherein the computer-executable instructions, when executed by a computer processor, are used to perform the slicing method for the video according claim 8.

17. The electronic device according to claim 14, wherein updating the compensation feature according to the first frame feature, comprises:
splicing the first frame feature, the motion compensation information and the compensation feature to obtain a spliced image;
determining a first weight of the spliced image in a channel dimension, and a second weight of the spliced image in a spatial dimension, respectively; and
processing the first frame feature according to the first weight and the second weight to obtain an update parameter, and updating the compensation feature according to the update parameter.

18. The electronic device according to claim 17, wherein determining the first weight of the spliced image in the channel dimension, and the second weight of the spliced image in the spatial dimension, respectively, comprises:
extracting a splicing feature of the spliced image, wherein the splicing feature and the first frame feature have an identical size;
pooling the splicing feature in the spatial dimension, and performing full connection on a pooling result to obtain the first weight of the spliced image in the channel dimension; and
performing convolution on feature maps of a plurality of channels in the splicing feature, and performing logistic regression on a convolution result to obtain the second weight of the spliced image in the spatial dimension.

19. The electronic device according to claim 17, wherein processing the first frame feature according to the first weight and the second weight to obtain the update parameter, comprises:
multiplying the first frame feature by the first weight and the second weight to obtain the update parameter.

20. The electronic device according to claim 17, wherein updating the compensation feature according to the update parameter, comprises:
pooling the compensation feature in the spatial dimension, and adding a pooling result to the update parameter.

21. The electronic device according to claim 14, wherein the motion compensation information comprises a motion vector and a residual; and
updating the compensation feature according to the first frame feature to obtain the second frame feature of the at least one predictive-frame, comprises:
updating an initial vector feature of the motion vector and an initial residual feature of the residual respectively according to the first frame feature to obtain a target vector feature and a target residual feature; and
determining the second frame feature of the at least one predictive-frame according to the target vector feature and the target residual feature.

22. The electronic device according to claim 14, wherein the motion compensation information of the at least one predictive-frame relative to the intra coding frame is determined based on following steps:
respectively taking the at least one predictive-frame as a starting point to circularly determine a reference frame of a current frame forwards according to the time sequence, and taking the reference frame as a new current frame until the reference frame is the intra coding frame;
accumulating motion compensation information between the current frame and the reference frame in a circulation process; and
obtaining, when the circulation process is stopped, the motion compensation information of the at least one predictive-frame relative to the intra coding frame.
